(19) United States
(12) Patent Application Publication
(10) Pub. No.: US 2008/0158444 A1
(43) Pub. Date: Jul. 3, 2008

(54) DIGITAL MEDIA PLAYER

(75) Inventor: Pai-Ko Chuang, Taipei Hsien (TW)

Correspondence Address: PAI PATENT & TRADEMARK LAW FIRM, 1001 FOURTH AVENUE, SUITE 3200, SEATTLE, WA, 98154, US

(73) Assignee: WISTRON NEWEB CORP., Taipei Hsien (TW)

(21) Appl. No.: 11/927,654

(22) Filed: Oct. 29, 2007

(30) Foreign Application Priority Data
Dec. 28, 2006 (TW) 95223043

(51) Int. Cl. H04N 5/64

(52) U.S. Cl. 348/836

(57) ABSTRACT

A digital media player includes a dock, a display module, and a connecting structure. The dock has a memory slot for receiving a memory device storing image information. The image information is transmitted to the display module through the connecting structure. The display module is detachably electronically connected to the dock via the connecting structure for displaying the image information.

### RELATED APPLICATIONS

This application claims priority to Taiwan Application Serial Number 95223043, filed Dec. 28, 2006, which is herein incorporated by reference.

### BACKGROUND

1. Field of Invention

The present invention relates to a digital media player. More particularly, the present invention relates to a detachable digital media player.

2. Description of Related Art

With the rapid development of digital image processing technology and the wide use of digital cameras, digital media players have become important in the consumer electronic product market. A digital media player, such as a digital photo frame, has many advantages. For example, the digital photo may be displayed in the digital media player without developing films. The digital photo may also be displayed continuously in the digital media player.

The traditional digital media player, such as a digital photo frame, is designed as an integrated structure. Concerning with stock controlling, the variation of the shape of the digital media player is limited. The change of the digital media player design may increase stock pressure and fabricating cost. A large part of the digital media player cost is the display module and cost fluctuations of the display module are also obvious.

For the foregoing reasons, there is a need for reducing the stock pressure and increasing the design flexibility of the digital media player.

### SUMMARY

The present invention is directed to a digital media player, which satisfies the need of reducing stock pressure and increasing the design flexibility of the digital media player.

The digital media player includes a dock, a display module, and a connecting structure disposed on the dock. The dock has a main circuit board and a memory slot for receiving a memory device storing image information. The display module is detachably electronically connected to the dock via the connecting structure for displaying the image information stored in the memory device.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a schematic diagram of an embodiment of a digital media player of the invention;

FIG. 2 illustrates an oblique diagram of an embodiment of a dock of the digital media player of the invention;

FIG. 3 illustrates a front view diagram of an embodiment of a display module of the digital media player of the invention;

FIG. 4 illustrates a side view diagram of the embodiment of the display module the digital media player of the invention;

FIG. 5 illustrates a side view diagram of the embodiment of the dock of the digital media player of the invention; and

FIG. 6 illustrates an oblique diagram of an embodiment of a shaped device of the digital media player.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

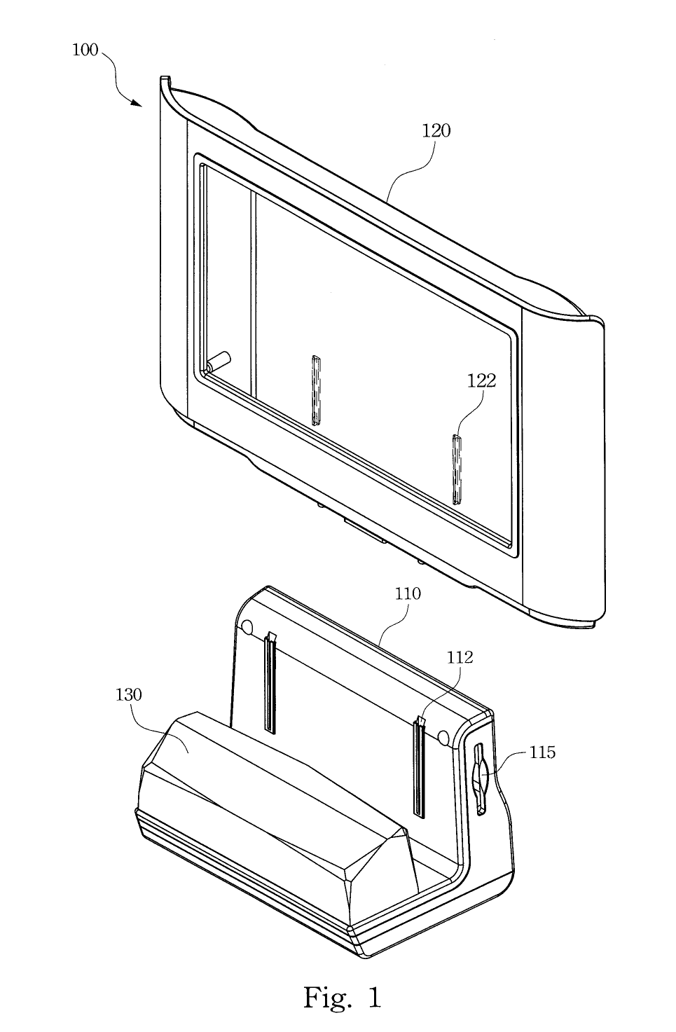

Refer to FIG. 1. FIG. 1 illustrates a schematic diagram of a digital media player of the invention. The digital media player 100 includes a dock 110, a display module 120, and a connecting structure (not shown). A main circuit board of the digital media player 100 is disposed in the dock 110. The display module 120 of the digital media player 100 may be assembled detachably. The digital media player 100 may display a digital image, such as a digital photo, an image file, a text file, or a motion picture. The dock 110 may have a memory slot 115. A memory device storing with image information may insert into the memory slot 115. The memory slot 115 may be utilized as an adapter device of the dock 110 for transmitting the image information stored in the memory device to the main circuit board. The image information in the main circuit board of the dock 110 may be further transmitted to the display module 120 through the connecting structure. The memory device may be a flash memory card, such as a multi media card (MMC), a secured digital card (SD card), a compact flash card (CF card), or a memory stick (MS). The type of the memory slot 115 may be the same as the memory device. The compatibility between the memory slot 115 and the memory device may be expanded by adding a card reader.

The dock 110 and the display module 120 of the digital media player 100 are respectively produced. The size of the dock 110 and the shape of the display module 120 may be selected and assembled to form the digital media player 100 as desired. That may increase the design flexibility to suit the market demand and reduce the stock pressure.

The digital media player 100 may further include a shaped device 130 disposed on the dock 110 to improve the quality of the digital media player 100. For example, the shaped device 130 may be a translucent device, or an art product with technical shape. The shaped device 130 may be laser carved or embossed to form a company logo on a surface of the shaped device 130. The shaped device 130 may be designed and produced individually to fit different requirements. Then, the shaped device 130 may be assembled with the dock 110 and the display module 120 to form the digital media player 100 as desired. The producing cost of the digital media player 100 may be reduced.

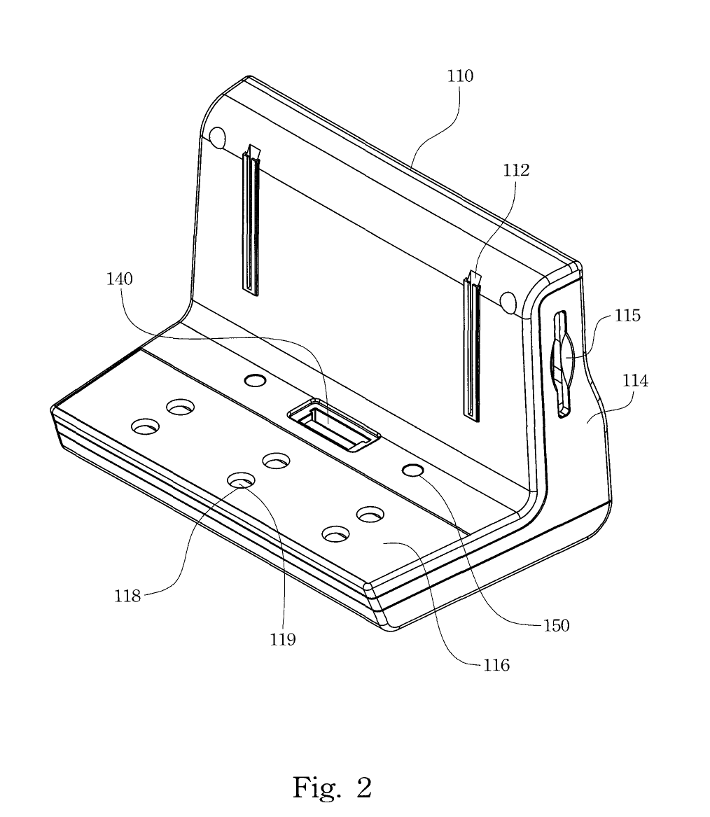

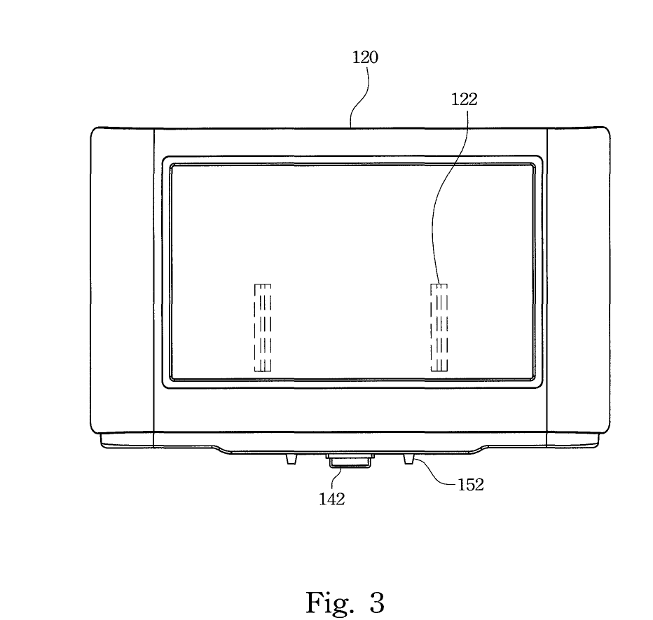

Refer to FIG. 2 and FIG. 3. FIG. 2 illustrates an oblique diagram of an embodiment of the dock of the digital media player of the invention. FIG. 3 illustrates a front view diagram of an embodiment of the display module of the digital media player of the invention. The connecting structure of the digital media player 100 is disposed between the dock 110 and the display module 120. The connecting structure includes an adapter slot 140 with a plurality of internal pins and an adapter plug 142 with an internal socket. The adapter slot 140 may be disposed on the dock 110. The adapter plug 142 may be disposed on the display module 120 and correspond to the adapter slot 140. The image information of the digital media player 100 may be transmitted from the dock 110 to the display module 120 by coupling the adapter plug 142 and the adapter slot 140. The digital media player 100 may further have a position structure and a fixing structure to position the display module 120 on the dock 110 while assembling the digital media player 100 and to fix the display module 120 on the dock 110 when the digital media player is assembled. The dock 110 may have a position portion 114, an adapter portion 116, and a bending portion to connect the position portion 114 with the adapter portion 116. The position portion 114 may be disposed vertically and the adapter portion 116 may be disposed horizontally. The main circuit board and the memory slot 115 may be disposed in the position portion 114 of the dock 110.

The position structure may be disposed between the display module 120 and the position portion 114. The position structure may have a position groove 112 and a protrusion 122. The protrusion 122 may be inserted in the position groove 112 to precisely couple the adapter plug 142 of the display module 120 and the adapter slot 140 of the dock 110. In this embodiment, the protrusion 122 is disposed on a surface without the display function of the display module 120, and the position groove 112 is disposed on the position portion 114 and corresponds to the protrusion 122. The fixing structure may be at least a wedge 152 and at least a wedge cavity 150. The wedge 152 may couple with the wedge cavity 150 to further fix the display module 120 on the dock 110. In this embodiment, the wedge 152 is disposed on the display module 120, and the wedge cavity 150 is disposed on the adapter portion 116 of the dock 110 and corresponds to the wedge 152.

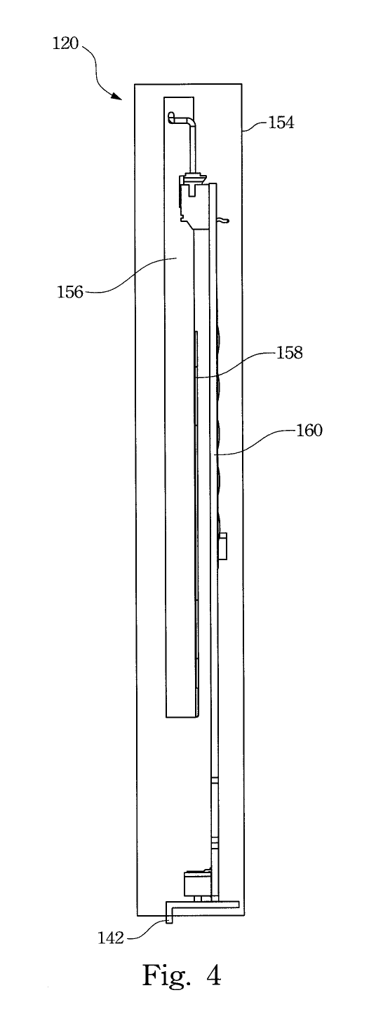

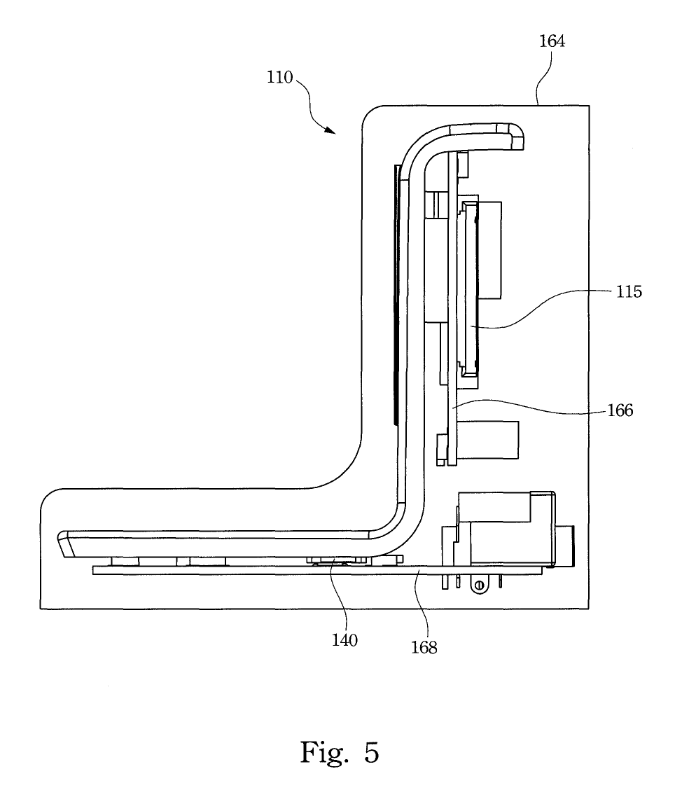

Refer to FIG. 4 and FIG. 5. FIG. 4 illustrates a side view diagram of the embodiment of the display module the digital media player of the invention. FIG. 5 illustrates a side view diagram of the embodiment of the dock of the digital media player of the invention. The display module 120 may include a display module frame 154, a display module panel 156 disposed in the display module frame 154, a display circuit board 160, a bus line 158 to connect the display panel 156 and the display circuit board 160, and the adapter plug 142. The dock 110 includes a base frame 164, the main circuit board 166, the memory slot 115, an adapter circuit board 168 electrically connected with the main circuit board 166, and the adapter slot 140. The main circuit board 166 includes a microprocessor, a power circuit, an I/O port, and other peripheral devices.

The image information stored in the memory device may be transmitted to the main circuit board 166 through the memory slot 115. The image information in the main circuit board 166 may be further transmitted to the pins in the adapter slot 142 then be transmitted to the socket in the adapter plug 142, wherein the adapter slot 140 is coupled with the adapter plug 142. The image information received from the adapter plug 142 may be transmitted to the display circuit board 160 and the bus line 158 connected with. The image information may further be transmitted to the display panel 156 and be displayed. The bus line 158 may be a flexible printed circuit board (FPCB). A control panel and a control bottom of the digital media player 100 may be disposed on the display module 120. The bus line 158 may be utilized to integrate a signal from the image information and the control panel.

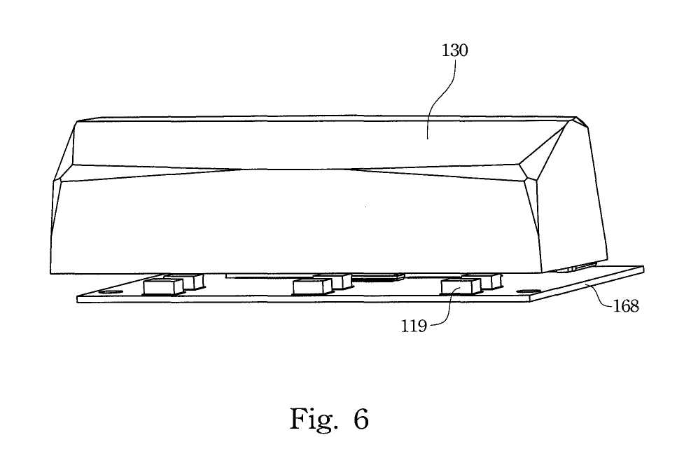

Refer to FIG. 2 and FIG. 6. FIG. 6 illustrates an oblique diagram of an embodiment of the shaped device of the digital media player. The shaped device 130 may be glued or screwed on the adapter portion 116 of the dock 110. The display module 120 may be disposed between the shaped device 130 and the position portion 114. The material of the shaped device 130 may be a translucent material, such as an acrylic, a glass, or a crystal. The material of the shaped device 130 may be an opaque material, such as a metal or a plastic. The adapter portion 116 of the dock 110 may have a light-emitting module disposed corresponding to the shaped devicel 30 if the shaped device 130 was a translucent device. A light from the light-emitting module may pass through the shaped device 130 to provide better vision effect. Refer to FIG. 6. A plurality of LEDs 119 in the light-emitting module may be controlled by the adapter circuit board 168. Refer to FIG. 2. The adapter portion 116 may have at least an opening 118. The LEDs 119 may be disposed in the openings 118. The light from the LEDs 119 of the light-emitting module may pass through the shaped device 130.

The display module and the dock of the digital media player may be produced individually then be assembled as the digital media player. The design flexibility may be increased and the design period may be shortened to suit the market requirements. The size and the shape of the digital media player may be selected and assembled as desired. The stock pressure of the digital media player may also be reduced.

Although the present invention has been described in considerable detail with reference to certain preferred embodiments thereof, other embodiments are possible. For example, the adapter plug may be disposed on the dock and the adapter slot may be disposed on the display module. The position groove may be disposed on the surface without display function of the display module and the protrusion may be disposed on the position portion. The main circuit board and the adapter circuit board may be designed integrated. Therefore, their spirit and scope of the appended claims should no be limited to the description of the preferred embodiments container herein.

What is claimed is:

1. A digital media player comprising:
a dock having a main circuit board and a memory slot for receiving a memory device storing image information;
a display module; and
a connecting structure disposed on the dock, wherein the display module detachably electronically connected to the dock via the connecting structure for displaying the image information stored in the memory device.

2. The digital media player of claim 1, wherein the dock comprises a position portion, a bending portion, and an adapter portion, the position portion is connected with the adapter portion by the bending portion.

3. The digital media player of claim 2, wherein the digital media player comprises a position structure disposed between the display module and the position portion to position the display module on the dock.

4. The digital media player of claim 3, wherein the position structure comprises a position groove and a protrusion, the protrusion is coupled with the position groove to position the display module and the dock.

5. The digital media player of claim 4, wherein the protrusion is disposed on a surface without a display function of the display module, the position groove is disposed on the position portion.

6. The digital media player of claim 4, wherein the position groove is disposed on a surface without the display function of the display module, the protrusion is disposed on the position portion.

7. The digital media player of claim 2, wherein the digital media player further comprises a shaped device disposed on the adapter portion of the dock, wherein the display module is disposed between the shaped device and the position portion.

8. The digital media player of claim 7, wherein the shaped device is a translucent device.

9. The digital media player of claim 8, wherein the adapter potion further comprises a light-emitting module disposed corresponding to the shaped device; a light from the light-emitting module is pass through the shaped device.

10. The digital media player of claim 9, wherein the adapter portion has at least an opening; the light-emitting module comprises at least a light-emitting diode disposed under the opening.

11. The digital media player of claim 8, wherein a material of the translucent device is an acrylic, a glass, or a crystal.

12. The digital media player of claim 7, wherein the shaped device is glued or screwed on the adapter portion.

13. A display module of a digital media player comprising:
a display frame;
a display panel disposed in the display frame;
a display circuit board disposed in the display frame to control the display panel; and
a connecting structure disposed at a bottom of the display module to receive an image information.

14. The display module of the digital media player of claim 13, wherein display module comprises a bus line to connect the display panel and the display circuit board.

15. A dock of the digital media player comprising:
a position portion having a main circuit board and a memory slot for receiving a memory device storing an image information;
an adapter portion; and
a bending portion to connect the position portion and the adapter portion, wherein the adapter portion is disposed horizontal.

16. The dock of the digital media player of claim 15, wherein the dock further comprises a shaped device disposed on the adapter portion.

17. The dock of the digital media player of claim 16, wherein the shaped device is a translucent device.

18. The dock of the digital media player of claim 17, wherein a material of the translucent device is acrylic, glass, or crystal.

19. The dock of the digital media player of claim 17, wherein the adapter portion further comprises a light-emitting module disposed corresponding to the shaped device; a light from the light-emitting module passes through the shaped device.

20. The dock of the digital media player of claim 19, wherein the adapter portion comprises at least an opening; the light-emitting module comprises at least a light-emitting diode disposed under the opening.
